(19) United States
(12) Patent Application Publication
(10) Pub. No.: US 2008/0299457 A1
(43) Pub. Date: Dec. 4, 2008

(54) NONAQUEOUS ELECTROLYTE SECONDARY BATTERY AND METHOD FOR MANUFACTURING POSITIVE ELECTRODE OF NONAQUEOUS ELECTROLYTE SECONDARY BATTERY

(76) Inventors: Yoshiyuki Muraoka, Osaka (JP); Hajime Nishino, Nara (JP); Shinji Kasamatsu, Osaka (JP); Takuji Hirano, Wakayama (JP); Miyuki Nakai, Osaka (JP)

Correspondence Address: MCDERMOTT WILL & EMERY LLP, 600 13TH STREET, NW, WASHINGTON, DC, 20005-3096, US

(21) Appl. No.: 12/132,961

(22) Filed: Jun. 4, 2008

(30) Foreign Application Priority Data
Jun. 4, 2007 (JP) 2007-147586

(51) Int. Cl. H01M 4/66

(52) U.S. Cl. 429/217; 429/246

(57) ABSTRACT

A nonaqueous electrolyte secondary battery including a positive electrode including a positive electrode current collector carrying a positive electrode material mixture layer thereon, a negative electrode including a negative electrode current collector carrying a negative electrode material mixture layer thereon, a separator provided between the positive electrode and the negative electrode and a nonaqueous electrolyte solution, wherein the positive electrode current collector is a conductive body containing aluminum and the positive electrode material mixture layer includes a first material mixture layer and a second material mixture layer formed on the first material mixture layer. The first material mixture layer is made of a first material mixture containing a first organic material which is soluble or dispersible in water and the second material mixture layer is made of a second material mixture containing a second organic material which is soluble or dispersible in an organic solvent.

### CROSS-REFERENCE TO RELATED APPLICATION

This non-provisional application claims priority under 35 U.S.C. §119(a) of Japanese Patent Application No. 2007-147586 filed in Japan on Jun. 4, 2007, the entire contents of which are hereby incorporated by reference.

### BACKGROUND OF THE INVENTION

1. Field of the Invention

The present invention relates to a nonaqueous electrolyte secondary battery such as a lithium ion secondary battery. In particular, it relates to a technology related to safety of the nonaqueous electrolyte secondary-battery.

2. Description of Related Art

In recent years, electronic devices have rapidly been converted to portable and wireless. As a driving source for such devices, there is a growing demand for a small-size, lightweight secondary battery having high energy density. A typical secondary battery which meets the demand is a nonaqueous electrolyte secondary battery. As a material of a negative electrode in the nonaqueous electrolyte secondary battery, an active material such as lithium metal or a lithium alloy, or a lithium intercalation compound based on carbon as a host substance (a substance capable of intercalating and deintercalating lithium ions) is used in general. Further, an aprotic organic solvent dissolving lithium salt such as LiClO₄ or LiPF₆ is used as an electrolyte.

To be more specific, the nonaqueous electrolyte secondary battery includes a negative electrode, a positive electrode and a separator. The negative electrode is made of the aforementioned negative electrode material and a negative electrode current collector carrying the negative electrode material thereon. The positive electrode is made of a positive electrode active material which is able to reversibly cause an electrochemical reaction with lithium ions (e.g., a lithium cobalt composite oxide) and a positive electrode current collector carrying the positive electrode active material thereon. The separator carries the electrolyte and is interposed between the negative and positive electrodes to prevent the occurrence of a short circuit between them.

The nonaqueous electrolyte secondary battery is manufactured in the following manner. First, the positive and negative electrodes are prepared in the form of a thin sheet or foil, respectively, and the positive and negative electrodes are stacked or wound in a spiral with the separator interposed therebetween to form a power generator element. Then, the power generator element is placed in a battery case made of iron or aluminum plated with stainless steel or nickel, and then a nonaqueous electrolyte solution is poured into the battery case. A lid is then fixed to the battery case to seal the battery case. In this manner, the nonaqueous electrolyte secondary battery is manufactured.

In general, when the lithium ion secondary battery is overcharged or an internal short circuit occurs in the lithium ion secondary battery, the lithium ion secondary battery generates heat and the battery temperature rises. Since the lithium ion secondary battery is likely to cause excessive heating at high temperature, improvement in safety of the lithium ion secondary battery has been required.

A probable reason for the temperature rise of the lithium ion secondary battery is as follows. When the battery enters an abnormal state due to the overcharge or the internal short circuit, the separator melts or shrinks to cause a short circuit between the positive and negative electrodes and large current flows through the short circuit. As a result, the temperature of the battery abruptly increases.

A principle cause of the excessive heating that occurs when the lithium ion secondary battery is left in a high temperature environment is that the positive electrode active material is unstable during charge at high temperature. To be more specific, during the charge at high temperature, oxygen is eliminated from the positive electrode active material (e.g., lithium cobalt composite oxide) and the eliminated active oxygen reacts with the electrolyte. The reaction generates reaction heat, which further increases the temperature of the battery. When the temperature increases to a further extent, the oxygen elimination from the positive electrode active material occurs more significantly and the reaction with the electrolyte occurs more actively, and therefore a larger amount of reaction heat is generated. This chain-reaction heat generation is considered as a cause of the excessive heating.

As a measure to improve thermal stability of the lithium ion secondary battery, a method for increasing electrical resistance of the active material has been proposed (cf. Patent Literature 1: Japanese Unexamined Patent Publication No. 2001-297763). To be more specific, lithium cobalt composite oxide which shows a coefficient of resistance of 1 mΩ·cm to 40 mΩ·cm, both inclusive, when the powder bulk density is 3.8 g/cm³ or lower, is used as the positive electrode active material to restrain the heat generation in the battery when the short circuit occurs.

As another measure to improve the thermal stability of the lithium ion secondary battery, a method for providing a resistive layer having a higher resistance than that of the current collector on the surface of the current collector has been proposed (cf. Patent Literature 2: Japanese Patent Publication No. 10-199574). To be more specific, large current discharge due to the short circuit is restrained by providing a resistive layer having a resistance of 0.1 to 100Ω·cm².

For providing an optimum resistive layer on the current collector as proposed by Patent Literature 2, it is inevitably necessary to select a material having an optimum resistance value and severely control the thickness of the resistance layer.

Further, according to the method proposed by Patent Literature 1, the electrical resistance of the positive electrode active material is increased. However, if the electrode is thinned down or the amount of the conductive material contained in the material mixture layer is increased, the current flowing through the short circuit increases. Therefore, the heat generation in the battery is hard to restrain.

### SUMMARY OF THE INVENTION

With the foregoing in mind, an object of the present invention is to provide a highly safe nonaqueous electrolyte secondary battery which easily restrains the excessive heating even if the internal short circuit occurs in the battery.

In order to achieve the aforementioned object, a nonaqueous electrolyte secondary battery according to a first aspect of the present invention includes a positive electrode including a positive electrode current collector carrying a positive electrode material mixture layer thereon, a negative electrode including a negative electrode current collector carrying a negative electrode material mixture layer thereon, a separator provided between the positive electrode and the negative electrode and a nonaqueous electrolyte solution, wherein the positive electrode current collector is a conductive body containing aluminum, the positive electrode material mixture layer includes a first material mixture layer and a second material mixture layer formed on the first material mixture layer, the first material mixture layer is made of a first material mixture containing a first organic material which is soluble or dispersible in water and the second material mixture layer is made of a second material mixture containing a second organic material which is soluble or dispersible in an organic solvent. The first material mixture layer is preferably a layer formed by drying a first solution mixture prepared by mixing the first material mixture with water and the second material mixture layer is preferably a layer formed by drying a second solution mixture prepared by mixing the second material mixture with an organic solvent.

Regarding the nonaqueous electrolyte secondary battery according to the first aspect of the invention, aluminum in the positive electrode current collector is reacted with water in the first solution mixture (paste) in the process of forming the first material mixture layer, thereby forming an aluminum oxide coating at an interface between the positive electrode current collector and the first material mixture layer. As a result, resistance at the interface between the positive electrode current collector and the positive electrode material mixture layer is increased. Therefore, even if the internal short circuit occurs in the battery and the separator melts away, the increased resistance between the positive and negative electrodes makes it possible to restrain a short circuit current flowing between the positive and negative electrodes. Thus, battery temperature rise due to the short circuit current is restrained and the battery is provided with excellent safety.

As a solvent for mixing the positive electrode active material, water is used to form the first material mixture layer, whereas the organic solvent is used to form the second material mixture layer. Therefore, even if lithium in the positive electrode active material is eluted in water in the process of forming the first material mixture layer, lithium in the positive electrode active material is not eluted in the organic solvent in the process of forming the second material mixture layer. Accordingly, the second material mixture layer compensates the decrease in battery capacity derived from the first material mixture layer. Thus, the battery is provided with superior electrical performance.

Regarding the nonaqueous electrolyte secondary battery according to the first aspect of the invention, an aluminum oxide coating is preferably formed at an interface between the positive electrode current collector and the first material mixture layer by a reaction between water in the first solution mixture and aluminum in the positive electrode current collector.

Regarding the nonaqueous electrolyte secondary battery according to the first aspect of the invention, the first material mixture preferably contains a conductive material made of a carbon material.

In this configuration, water produces the aluminum oxide coating at the interface between the positive electrode current collector and the first material mixture layer in the process of forming the first material mixture layer. At the same time, the conductive material made of the carbon material makes it possible to prevent further growth of the aluminum oxide coating at the interface with the repetition of charge and discharge of the battery. That is, a coating of a certain thickness, i.e., a resistive film having a certain resistance, is formed at the interface between the positive electrode current collector and the positive electrode material mixture layer. Therefore, the resistance at the interface between the positive electrode current collector and the positive electrode material mixture layer is increased and the increased resistance is kept unchanged. Thus, the battery property is kept consistent and the battery safety is ensured.

Regarding the nonaqueous electrolyte secondary battery according to the first aspect of the invention, the first material mixture preferably contains a positive electrode active material made of aluminum-containing lithium composite oxide.

In this configuration, aluminum in the positive electrode active material is eluted to form an aluminum oxide film at the interface between the positive electrode current collector and the positive electrode material mixture layer. As a result, a thick coating is provided at the interface between the positive electrode current collector and the positive electrode material mixture layer. Therefore, the battery is provided with higher safety.

Regarding the nonaqueous electrolyte secondary battery according to the first aspect of the invention, the first material mixture preferably contains a positive electrode active material made of nickel-containing lithium composite oxide.

In this configuration, the battery capacity is increased as the nickel content in the positive electrode active material is increased. Even if thermal stability of the positive electrode active material is decreased with the increase of the nickel content in the positive electrode active material, the configuration of the present invention makes it possible to restrain the battery temperature rise. Therefore, the positive electrode active material with high nickel content (i.e., highly thermally stable positive electrode active material) is used with safety.

Regarding the nonaqueous electrolyte secondary battery according to the first aspect of the invention, it is preferable that the first material mixture contains a first binder made of the first organic material and the second material mixture contains a second binder made of the second organic material.

In this configuration, a binder having compatibility with water is used as the first binder and a binder having compatibility with a solvent other than water (an organic solvent) is used as the second binder. Therefore, in the process of forming the second material mixture layer on the first material mixture layer, the first binder contained in the first material mixture layer is prevented from dissolving in the second solution mixture.

Regarding the nonaqueous electrolyte secondary battery according to the first aspect of the invention, it is preferable that the first binder contains polytetrafluoroethylene, denatured polytetrafluoroethylene, a tetrafluoroethylene-hexafluoropropylene copolymer or a denatured tetrafluoroethylene-hexafluoropropylene copolymer and the second binder contains polyvinylidene fluoride or denatured polyvinylidene fluoride.

In order to achieve the aforementioned object, a nonaqueous electrolyte secondary battery according to a second aspect of the present invention includes a positive electrode including a positive electrode current collector carrying a positive electrode material mixture layer thereon, a negative electrode including a negative electrode current collector carrying a negative electrode material mixture layer thereon, a separator provided between the positive electrode and the negative electrode and a nonaqueous electrolyte solution, wherein the positive electrode current collector is a conductive body containing aluminum and an undercoating containing an organic material which is soluble or dispersible in water and a conductive material made of a carbon material is provided between the positive electrode current collector and the positive electrode material mixture layer. The undercoating is preferably formed by drying a solution mixture prepared by mixing the organic material and the conductive material into water.

Regarding the nonaqueous electrolyte secondary battery according to the second aspect of the invention, water in the solution mixture (paste) is reacted with aluminum in the positive electrode current collector in the process of forming the undercoating, thereby forming an aluminum oxide coating at the interface between the positive electrode current collector and the undercoating. At the same time, the conductive material made of the carbon material makes it possible to prevent further growth of the aluminum oxide coating at the interface with the repetition of the charge and discharge of the battery. That is, a coating of a certain thickness, i.e., a resistive film having a certain resistance, is formed at the interface between the positive electrode current collector and the undercoating. Therefore, the resistance between the positive electrode current collector and the positive electrode material mixture layer is increased and the increased resistance is kept unchanged. Thus, the battery property is kept consistent and the battery safety is ensured.

Regarding the nonaqueous electrolyte secondary battery according to the second aspect of the invention, an aluminum oxide coating is preferably formed at an interface between the positive electrode current collector and the undercoating by a reaction between water in the solution mixture and aluminum in the positive electrode current collector.

Regarding the nonaqueous electrolyte secondary battery according to the first or second aspect of the invention, a positive electrode active material contained in the positive electrode material mixture layer is preferably a compound represented by a general formula of LiNiₓCo_{y}Al_{1-x-y}O₂, where 0.7<x<1.0 and 0<y<0.3.

The nonaqueous electrolyte secondary battery according to the first or second aspect of the invention is a highly safe battery. Therefore, a positive electrode active material, even if it is less thermally stable, is used with safety.

In order to achieve the aforementioned object, a method for manufacturing the positive electrode of the nonaqueous electrolyte secondary battery according to the first aspect of the invention includes the steps of: (a) applying to an aluminum-containing positive electrode current collector a first material mixture slurry prepared by mixing a first material mixture containing a first organic material which is soluble or dispersible in water with water and drying the applied slurry to form a first material mixture layer; and (b) applying to the first material mixture layer a second material mixture slurry prepared by mixing a second material mixture containing a second organic material which is organic solvent-soluble or organic solvent-dispersible with an organic solvent and drying the applied slurry to form a second material mixture layer after the step (a).

According to the method for manufacturing the positive electrode of the nonaqueous electrolyte secondary battery according to the first aspect of the invention, aluminum in the positive electrode current collector is reacted with water in the first material mixture slurry in the process of forming the first material mixture layer, thereby forming an aluminum oxide coating at the interface between the positive electrode current collector and the first material mixture layer. Therefore, the resistance at the interface between the positive electrode current collector and the positive electrode material mixture layer is increased.

As a solvent for mixing the positive electrode active material, water is used to form the first material mixture layer, whereas the organic solvent is used to form the second material mixture layer. Therefore, even if lithium in the positive electrode active material is eluted in water in the first material mixture slurry, lithium in the positive electrode active material is not eluted in the organic solvent in the second material mixture slurry.

Regarding the method for manufacturing the positive electrode of the nonaqueous electrolyte secondary battery according to the first aspect of the invention, it is preferable that in the step (a), an aluminum oxide coating is formed at an interface between the positive electrode current collector and the first material mixture layer by a reaction between water in the first material mixture slurry and aluminum in the positive electrode current collector.

Regarding the method for manufacturing the positive electrode of the nonaqueous electrolyte secondary battery according to the first aspect of the invention, the first material mixture preferably contains a conductive material made of a carbon material.

In this configuration, water produces the aluminum oxide coating at the interface between the positive electrode current collector and the first material mixture layer in the process of forming the first material mixture layer. At the same time, the conductive material made of the carbon material makes it possible to prevent further growth of the aluminum oxide coating at the interface with the repetition of charge and discharge of the battery. That is, a coating of a certain thickness, i.e., a resistive film having a certain resistance, is formed at the interface between the positive electrode current collector and the positive electrode material mixture layer. Therefore, the resistance at the interface between the positive electrode current collector and the positive electrode material mixture layer is increased and the increased resistance is kept constant.

In order to achieve the aforementioned object, a method for manufacturing the positive electrode of the nonaqueous electrolyte secondary battery according to a second aspect of the invention includes the steps of: (a) applying to an aluminum-containing positive electrode current collector a slurry prepared by mixing an organic material which is soluble or dispersible in water and a conductive material made of a carbon material into water and drying the applied slurry to form an undercoating; and (b) applying to the undercoating a material mixture slurry made of a material mixture and drying the applied slurry to form a positive electrode material mixture layer after the step (a).

According to the method for manufacturing the positive electrode of the nonaqueous electrolyte secondary battery according to the second aspect of the invention, water in the slurry is reacted with aluminum in the positive electrode current collector in the process of forming the undercoating, thereby forming an aluminum oxide coating at the interface between the positive electrode current collector and the undercoating. At the same time, the conductive material made of the carbon material makes it possible to prevent further growth of the aluminum oxide coating at the interface with the repetition of charge and discharge of the battery. That is, a coating of a certain thickness, i.e., a resistive film having a certain resistance, is formed at the interface between the positive electrode current collector and the undercoating.

Regarding the method for manufacturing the positive electrode of the nonaqueous electrolyte secondary battery according to the second aspect of the invention, it is preferable that in the step (a), an aluminum oxide coating is formed at an interface between the positive electrode current collector and the undercoating by a reaction between water in the slurry and aluminum in the positive electrode current collector.

As described above, according to the nonaqueous electrolyte secondary battery and the method for manufacturing the positive electrode of the nonaqueous electrolyte secondary battery of the present invention, a nonaqueous electrolyte secondary battery is provided with excellent safety and superior electrical performance.

### BRIEF DESCRIPTION OF THE DRAWINGS

FIG. 1 is a vertical sectional view illustrating the structure of a nonaqueous electrolyte secondary battery according to Embodiment 1 of the present invention.

FIG. 2 is an enlarged sectional view illustrating the structure of a positive electrode of the nonaqueous electrolyte secondary battery according to Embodiment 1 of the present invention.

FIG. 3 is an enlarged sectional view illustrating a positive electrode of a nonaqueous electrolyte secondary battery according to Embodiment 2 of the present invention.

### DETAILED DESCRIPTION OF THE INVENTION

Hereinafter, embodiments of the present invention will be described with reference to the drawings.

### Embodiment 1

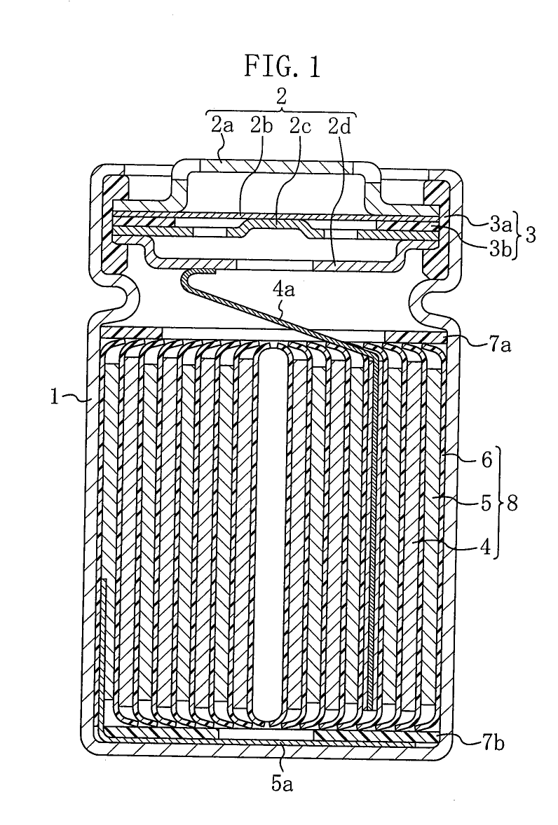

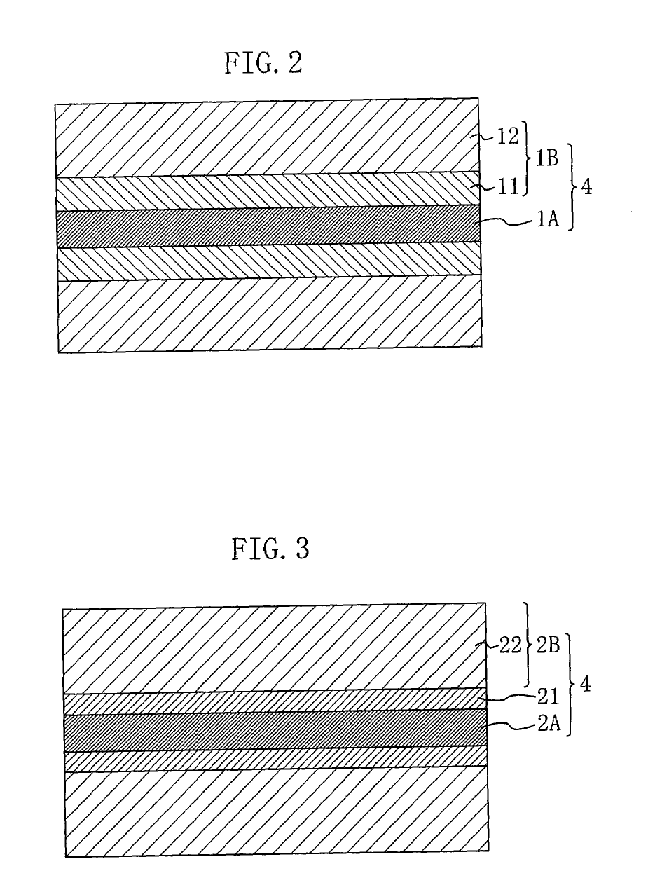

As an example of a nonaqueous electrolyte secondary battery according to Embodiment 1 of the present invention, a lithium ion secondary battery is explained with reference to FIGS. 1 and 2. FIG. 1 is a vertical sectional view illustrating the structure of the nonaqueous electrolyte secondary battery according to Embodiment 1 of the present invention.

The nonaqueous electrolyte secondary battery of the present embodiment includes a battery case 1 made of stainless steel, for example, and an electrode group 8 contained in the battery case 1 as shown in FIG. 1.

An opening is formed in a top face of the battery case 1. A sealing plate 2 is crimped to the opening with a gasket 3 interposed therebetween. Specifically, the sealing plate 2 includes a metal cap 2a, a metal safety valve 2b, a metal foil valve 2c and a metal filter 2d and the gasket 3 includes an outer gasket 3a and an inner gasket 3b. The opening is sealed in this manner.

The electrode group 8 includes a positive electrode 4, a negative electrode 5 and a separator 6 made of polyethylene, for example. The positive electrode 4 and the negative electrode 5 are wound into a spiral with the separator 6 interposed therebetween. An upper insulating plate 7a is provided above the electrode group 8 and a lower insulating plate 7b is provided below the electrode group 8.

A positive electrode lead 4a made of aluminum is fixed to the positive electrode 4 at one end and is connected to the sealing plate 2 which also functions as a positive electrode terminal at the other end. A negative electrode lead 5a made of nickel is fixed to the negative electrode 5 at one end and is connected to the battery case 1 which also functions as a negative electrode terminal at the other end.

Hereinafter, the structure of the positive electrode of the nonaqueous electrolyte secondary battery according to Embodiment 1 of the present invention is now explained in detail with reference to FIG. 2. FIG. 2 is an enlarged sectional view illustrating the structure of the positive electrode of the nonaqueous electrolyte secondary battery according to Embodiment 1 of the present invention.

As shown in FIG. 2, the positive electrode 4 includes a positive electrode current collector 1A and a positive electrode material mixture layer 1B including a first material mixture layer 11 and a second material mixture layer 12 stacked in this order. An aluminum oxide coating (not shown) is formed at an interface between the positive electrode current collector 1A and the first material mixture layer 11.

### <Positive Electrode Current Collector>

The positive electrode current collector 1A is a plate-like component made of aluminum. As the positive electrode current collector 1A, a long porous conductive substrate or a long nonporous conductive substrate may be used. The thickness of the positive electrode current collector 1A is not particularly limited, but it is preferably 1 μm to 500 μm, both inclusive, more preferably 5 μm to 20 μm, both inclusive. When the thickness of the positive electrode current collector 1A is in this range, the weight of the positive electrode 4 is reduced without reducing its strength.

### <Positive Electrode Material Mixture Layer>

### —First Material Mixture Layer—

The first material mixture layer 11 is made of a first material mixture containing a first organic material which is soluble or dispersible in water. In other words, the first material mixture layer 11 is a layer formed by drying a first solution mixture prepared by mixing the first material mixture with water. The first material mixture preferably contains other materials than the positive electrode active material (e.g., lithium composite oxide), such as a conductive material. As the first organic material, a first binder made of an organic material which is soluble or dispersible in water is preferably used.

Examples of the first binder contained in the first material mixture layer 11 include polytetrafluoroethylene, denatured polytetrafluoroethylene, a tetrafluoroethylene-hexafluoropropylene copolymer (FEP) or a denatured tetrafluoroethylene-hexafluoropropylene copolymer. These materials are preferable in view of thermal stability and chemical stability.

### —Second Material Mixture Layer—

The second material mixture layer 12 is made of a second material mixture containing a second organic material which is soluble or dispersible in an organic solvent. In other words, the second material mixture layer 12 is a layer formed by drying a second solution mixture prepared by mixing the second material mixture with an organic solvent. The second material mixture preferably contains other materials than the positive electrode active material (e.g., lithium composite oxide), such as a conductive material. As the second organic material, a second binder made of an organic material which is soluble or dispersible in an organic solvent is preferably used.

Examples of the second binder contained in the second material mixture layer 12 include polyvinylidene fluoride or denatured polyvinylidene fluoride. These materials are preferable in view of thermal stability and chemical stability.

In the present embodiment, both of the first material mixture layer 11 and the second material mixture layer 12 contain the positive electrode active material. However, the present invention is not limited thereto. The positive electrode active material may be contained at least in the second material mixture layer 12.

### —Conductive Material—

Examples of the conductive material contained in the positive electrode material mixture layer 1B include graphites such as natural graphite and artificial graphite, carbon blacks such as acetylene black (AB), Ketjen black, channel black, furnace black, lamp black and thermal black, conductive fibers such as carbon fiber and metal fiber, carbon fluoride, metal powders such as aluminum, conductive whiskers such as zinc oxide and potassium titanate, conductive metal oxides such as titanium oxide, organic conductive materials such as a phenylene derivative, etc.

### —Positive Electrode Active Material—

Examples of the positive electrode active material include lithium-containing compounds such as LiCoO₂, LiNiO₂, LiMnO₂, LiCoNiO₂, LiCoMO_{z}, LiNiMO_{z}, LiMn₂O₄, LiMnMO₄, LiMePO₄, Li₂MePO₄F (M=at least one of Na, Mg, Sc, Y, Mn, Fe, Co, Ni, Cu, Zn, Al, Cr, Pb, Sb and B), etc. The lithium-containing compounds in which an element is partially substituted with a different element may also be used. The positive electrode active material may be surface-treated, e.g., hydrophobidized, with metal oxide, lithium oxide or a conductive material.

Now, a method for manufacturing the positive electrode of the nonaqueous electrolyte secondary battery according to Embodiment 1 of the present invention is described in detail.

First, a first material mixture containing a first organic material which is soluble or dispersible in water is mixed with water to prepare first material mixture slurry. The obtained first material mixture slurry is applied to a positive electrode current collector (1A in FIG. 2) and dried to form a first material mixture layer (11 in FIG. 2). The first material mixture preferably contains other materials than the positive electrode active material, such as a conductive material. As the first organic material, a first binder made of an organic material which is soluble or dispersible in water is preferably used.

In this process, water in the first material mixture slurry is reacted with aluminum in the positive electrode current collector to form an aluminum oxide coating at an interface between the positive electrode current collector and the first material mixture layer (the coating is extremely thin and therefore not shown in FIG. 2).

Then, a second material mixture containing a second organic material which is soluble or dispersible in an organic solvent is mixed with N-methylpyrrolidone to prepare second material mixture slurry. The obtained second material mixture slurry is applied to the first material mixture layer and dried to form a second material mixture layer (12 in FIG. 2). The second material mixture preferably contains other materials than the positive electrode active material such as a conductive material. As the second organic material, a second binder made of an organic material which is soluble or dispersible in N-methyl pyrrolidone is preferably used.

In this way, a positive electrode (4 in FIG. 2) is produced in which a positive electrode material mixture layer (1B in FIG. 2) including the first material mixture layer and the second material mixture layer stacked in this order is provided on each of the surfaces of the positive electrode current collector.

The method for manufacturing the positive electrode of the nonaqueous electrolyte secondary battery according to the present invention is not limited to the one described above. For example, the thus formed first material mixture layer may be heat-treated at a predetermined temperature or the second material mixture layer thus formed may be heat-treated at a predetermined temperature.

According to the present embodiment, water in the first material mixture slurry is reacted with aluminum in the positive electrode current collector in the process of forming the first material mixture layer, thereby forming an aluminum oxide coating at the interface between the positive electrode current collector and the first material mixture layer. As a result, resistance at the interface between the positive electrode current collector and the positive electrode material mixture layer is increased. Therefore, even if the internal short circuit occurs in the battery and the separator melts away, the increased resistance between the positive and negative electrodes makes it possible to restrain a short circuit current flowing between the positive and negative electrodes. Thus, battery temperature rise due to the short circuit current is restrained and the battery is provided with excellent safety.

As a solvent for mixing the positive electrode active material, water is used to form the first material mixture layer, whereas a solvent different from water (e.g., N-methyl pyrrolidone) is used to form the second material mixture layer. Therefore, even if lithium in the positive electrode active material is eluted in water in the first material mixture slurry, lithium in the positive electrode active material is not eluted in N-methyl pyrrolidone in the second material mixture slurry. Accordingly, the second material mixture layer compensates the decrease in battery capacity derived from the first material mixture layer. Thus, the battery is provided with superior electrical performance.

A binder having compatibility with water is used as the first binder and a binder having compatibility with other solvent than water (e.g., N-methylpyrrolidone) is used as the second binder. Therefore, in the process of forming the second material mixture layer on the first material mixture layer, the first binder contained in the first material mixture layer is prevented from dissolving in the second material mixture slurry (N-methyl pyrrolidone).

As the positive electrode active material, the first material mixture layer preferably contains aluminum (Al)-containing lithium composite oxide.

If the aluminum-containing lithium composite oxide is used, aluminum in the positive electrode active material is eluted to form an aluminum oxide film at the interface between the positive electrode current collector and the positive electrode material mixture layer. As a result, a thick coating is formed at the interface between the positive electrode current collector and the positive electrode material mixture layer. Therefore, the battery is provided with higher safety.

As the positive electrode active material, the first material mixture layer preferably contains nickel (Ni)-containing lithium composite oxide.

If the nickel-containing lithium composite oxide is used, the battery capacity is increased as the nickel content in the positive electrode active material is increased. Even if thermal stability of the positive electrode active material is decreased with the increase of the nickel content in the positive electrode active material, the configuration of the present invention makes it possible to restrain the battery temperature rise. Therefore, the positive electrode active material with high nickel content (i.e., highly thermally stable positive electrode active material) is used with safety.

Hereinafter, the structure of the negative electrode is described in detail.

The negative electrode (5 in FIG. 1) includes a negative electrode current collector and a negative electrode material mixture layer. The negative electrode material mixture layer is formed on each of the surfaces of the negative electrode current collector. The negative electrode material mixture layer preferably contains other materials than the negative electrode active material such as a binder and a conductive material.

### <Negative Electrode Current Collector>

The negative electrode current collector is a plate-like conductive component. As the negative electrode current collector, a long porous conductive substrate or a long nonporous conductive substrate may be used. The negative electrode current collector may be made of stainless steel, nickel or copper. The thickness of the negative electrode current collector is not particularly limited, but it is preferably 1 μm to 500 μm, both inclusive, more preferably 5 μm to 20 μm, both inclusive. When the thickness of the negative electrode current collector is in this range, the weight of the negative electrode 5 is reduced without reducing its strength.

### <Negative Electrode Material Mixture Layer>

### —Binder—

Examples of the binder contained in the negative electrode material mixture layer include, PVDF, polytetrafluoroethylene, polyethylene, polypropylene, an aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinyl pyrrolidone, polyether, polyether sulphone, hexafluoropolypropylene, styrene-butadiene rubber, carboxymethyl cellulose, etc. Examples of the binder include a copolymer of two or more monomers selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethylvinylether, acrylic acid and hexadiene or a mixture of two or more of them.

### —Conductive Material—

Examples of the conductive material contained in the negative electrode material mixture layer include graphites such as natural graphite and artificial graphite, carbon blacks such as acetylene black, Ketjen black, channel black, furnace black, lamp black and thermal black, conductive fibers such as carbon fiber and metal fiber, carbon fluoride, metal powders such as aluminum, conductive whiskers such as zinc oxide and potassium titanate, conductive metal oxides such as titanium oxide, organic conductive materials such as a phenylene derivative, etc.

### —Negative Electrode Active Material—

Examples of the negative electrode active material include metals, metal fibers, carbon materials, oxides, nitrides, tin compounds, silicon compounds, various kinds of alloys, etc. In particular, monomers such as silicon (Si) and tin (Sn), silicon compounds or tin compounds are preferably used as they have high capacity density. Examples of the carbon materials include various natural graphites, coke, partially graphitized carbon, carbon fiber, spherical carbon, various artificial graphites, amorphous carbon etc. Examples of the silicon compounds include SiOx (0.05<x<1.95), a silicon alloy in which Si is partially substituted with at least one or more element selected from the group consisting of B, Mg, Ni, Ti, Mo, Co, Ca, Cr, Cu, Fe, Mn, Nb, Ta, V, W, Zn, C, N and Sn, a silicon solid solution, etc. Examples of the tin compounds include Ni₂Sn4, Mg₂Sn, SnOx (0<x<2), SnO₂, SnSiO₃, etc. One of the negative electrode active materials may solely be used or two or more of them may be used in combination.

Now, a method for manufacturing the negative electrode is described in detail.

First, a negative electrode material mixture is mixed with a solvent to prepare negative electrode material mixture slurry. The obtained negative electrode material mixture slurry is applied to the negative electrode current collector and dried. In this way, a negative electrode is produced in which a negative electrode material mixture layer is provided on each of the surfaces of the negative electrode current collector. The negative electrode material mixture slurry preferably contains other materials than the negative electrode active material, such as a binder and a conductive material.

Next, the separator is described in detail.

As the separator (6 in FIG. 1) interposed between the positive electrode (4 in FIG. 1) and the negative electrode (5 in FIG. 1), a thin microporous film, woven fabric or nonwoven fabric having high ion permeability, predetermined mechanical strength and insulating property is used. For example, polyolefin such as polypropylene and polyethylene is preferably used as the separator material in view of battery safety because it shows excellent durability and has a shutdown function. The thickness of the separator is generally 10 μm to 300 μm, both inclusive, but preferably it is in the range of 10 μm to 40 μm, both inclusive. The separator thickness is more preferably in the range of 10 μm to 30 μm, both inclusive, and it is much more preferably in the range of 15 μm to 25 μm, both inclusive. The thin microporous film may be a monolayer film made of a single material, or a composite or multilayer film made of more than one or two materials. The porosity of the separator is preferably in the range of 30% to 70%, both inclusive, more preferably it is 35% to 60%, both inclusive. The “porosity” is the ratio of volume of pores with respect to the total volume of the separator.

The nonaqueous electrolyte is now described in detail.

The nonaqueous electrolyte may be a liquid, gelled or solid nonaqueous electrolyte.

The liquid nonaqueous electrolyte (nonaqueous electrolyte solution) may contain an electrolyte (e.g., lithium salt) and a nonaqueous solvent dissolving the electrolyte.

The gelled nonaqueous electrolyte may contain a nonaqueous electrolyte and a polymer material supporting the nonaqueous electrolyte. Suitable examples of the polymer material include polyvinylidene fluoride, polyacrylonitrile, polyethylene oxide, polyvinyl chloride, polyacrylate, polyvinylidene fluoride hexafluoropropylene, etc.

The solid nonaqueous electrolyte may contain a polymer solid electrolyte.

The nonaqueous electrolyte solution is now described in more detail.

A known nonaqueous solvent may be used as the nonaqueous solvent dissolving the electrolyte. The nonaqueous solvent is not particularly limited, but cyclic carbonate, chain carbonate or cyclic carboxylate is preferably used. Examples of the cyclic carbonate include propylene carbonate (PC), ethylene carbonate (EC), etc. Examples of the chain carbonate include diethyl carbonate (DEC), ethylmethyl carbonate (EMC), dimethyl carbonate (DMC), etc. Examples of the cyclic carboxylate include γ-butyrolactone (GBL), γ-valerolactone (GVL), etc. One of the nonaqueous solvents may solely be used or two or more of them may be used in combination. The amount of the electrolyte dissolved in the nonaqueous solvent is preferably in the range of 0.5 mol/m³ to 2 mol/m³, both inclusive.

Examples of the electrolyte dissolved in the nonaqueous solvent include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic lithium carboxylate, LiCl, LiBr, LiI, chloroborane lithium, borates, imidates, etc. Examples of the borates include bis(1,2-benzenediolate(2-)-O,O′)lithium borate, bis (2,3-naphthalenediolate(2-)-O,O′)lithium borate, bis(2,2′-biphenyldiolate(2-)-O,O′)lithium borate, bis(5-fluoro-2-olate-1-benzenesulfonic acid-O,O′)lithium borate, etc. Examples of the imidates include lithium bis(trifluoromethanesulfonyl)imide ((CF₃SO₂)₂NLi), lithium (trifluoromethanesulfonyl) (nonafluorobutanesulfonyl)imide (LiN(CF₃SO₂)(C₄F₉SO₂)), lithium bis(pentafluoroethanesulfonyl)imide ((C₂F₅SO₂)₂NLi), etc. One of the electrolytes may solely be used or two or more of them may be used in combination.

The nonaqueous electrolyte solution may contain an additive which is decomposed on the negative electrode to form a coating having high lithium ion permeability such that charge-discharge efficiency of the battery is improved. Examples of the additive having such function include vinylene carbonate (VC), 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinylethylene carbonate (VEC), divinylethylene carbonate, etc. One of the compounds may solely be used or two or more of them may be used in combination. Among these compounds, at least one compound selected from the group consisting of vinylene carbonate, vinylethylene carbonate and divinylethylene carbonate is preferably used. In these compounds, a hydrogen atom may partially be substituted with a fluorine atom.

The nonaqueous electrolyte solution may contain a known benzene derivative which is decomposed to form a coating on the electrode when the battery is overcharged such that the battery is inactivated. The benzene derivative having such function may preferably be the one having a cyclic compound group on or adjacent to a phenyl group. Examples of the cyclic compound group include a phenyl group, a cyclic ether group, a cyclic ester group, a cycloalkyl group, a phenoxy group, etc. Examples of the benzene derivative include cyclohexylbenzene, biphenyl, diphenyl ether, etc. These may be used solely or two or more of them may be used in combination. The content of the benzene derivative relative to the nonaqueous solvent is preferably not higher than 10 vol % of the total volume of the nonaqueous solvent.

In the present embodiment, the lithium ion secondary battery is taken as an example of the nonaqueous electrolyte secondary battery and its structure was described with reference to FIG. 1. However, the present invention is not particularly limited thereto. To be more specific, the lithium ion secondary battery is not limited to be cylindrical but may be prism-shaped, or it may be a high-power lithium ion secondary battery. The structure of the electrode group 8 in the lithium ion secondary battery is not limited to the spiral provided by wounding the positive electrode 4 and the negative electrode 5 with the separator 6 interposed therebetween (see FIG. 1). The positive and negative electrodes may be stacked together with the separator interposed therebetween.

### Modified Embodiment

Hereinafter, a modified embodiment of the nonaqueous electrolyte secondary battery of the present invention is briefly explained. Only the difference between the modified embodiment and Embodiment 1 is described below and overlapping explanation is omitted.

The modified embodiment is different from Embodiment 1 in the following point.

In Embodiment 1, a common conductive material is contained in the first material mixture slurry. In the modified embodiment, however, the first material mixture slurry contains a conductive material made of a carbon material.

Accordingly, water produces the aluminum oxide coating at the interface between the positive electrode current collector and the positive electrode material mixture layer in the process of forming the first material mixture layer. At the same time, the conductive material made of the carbon material makes it possible to prevent further growth of the aluminum oxide coating at the interface with the repetition of charge and discharge of the battery. That is, a coating of a certain thickness, i.e., a resistive film having a certain resistance, is formed at the interface between the positive electrode current collector and the positive electrode material mixture layer. Therefore, the resistance at the interface between the positive electrode current collector and the positive electrode material mixture layer is increased and the increased resistance is kept unchanged. Thus, the battery property is kept consistent and the battery safety is ensured.

### Embodiment 2

Hereinafter, a nonaqueous electrolyte secondary battery according to Embodiment 2 of the present invention is described in detail with reference to FIG. 3. FIG. 3 is an enlarged sectional view illustrating a positive electrode of the nonaqueous electrolyte secondary battery according to Embodiment 2 of the present invention. Only the difference between the present embodiment and Embodiment 1 is described below and overlapping explanation is omitted.

Embodiment 2 is different from Embodiment 1 in the following point.

The nonaqueous electrolyte secondary battery of Embodiment 1 includes, as shown in FIG. 2, the positive electrode current collector 1A and the positive electrode material mixture layer 1B which is prepared by stacking the first material mixture layer 11 (a layer formed by applying and drying the first material mixture slurry prepared by mixing the first material mixture with water) and the second material mixture layer 12 (a layer formed by applying and drying the second material mixture slurry prepared by mixing the second material mixture with an organic solvent) in this order. The aluminum oxide coating (not shown) is formed at the interface between the positive electrode current collector 1A and the positive electrode material mixture layer 1B.

Different from Embodiment 1, the nonaqueous electrolyte secondary battery of the present embodiment includes, as shown in FIG. 3, a positive electrode current collector 2A, an undercoating 21 (a layer formed by applying and drying a slurry prepared by mixing an organic material which is soluble or dispersible in water and a conductive material made of a carbon material into water) and a positive electrode material mixture layer 2B made of a layer 22 formed by applying and drying a material mixture slurry prepared by mixing a material mixture with a solvent. An aluminum oxide coating (not shown) is formed at the interface between the positive electrode current collector 2A and the undercoating 21.

As the organic material which is soluble or dispersible in water, polytetrafluoroethylene, denatured polytetrafluoroethylene, a tetrafluoroethylene-hexafluoropropylene copolymer (FEP) or a denatured tetrafluoroethylene-hexafluoropropylene copolymer is preferably used in view of thermal stability and chemical stability.

According to the present embodiment, the same effect as that obtained in the above-described modified embodiment is provided. To be more specific, water in the slurry is reacted with aluminum in the positive electrode current collector in the process of forming the undercoating, thereby forming the aluminum oxide coating at the interface between the positive electrode current collector and the undercoating. At the same time, the conductive material made of the carbon material prevents further growth of the aluminum oxide coating at the interface with the repetition of charge and discharge of the battery. That is, a coating of a certain thickness, i.e., a resistive film having a certain resistance, is formed at the interface between the positive electrode current collector 2A and the undercoating 21. Therefore, the resistance at the interface between the positive electrode current collector and the positive electrode material mixture layer is increased and the increased resistance is kept unchanged. Thus, the battery property is kept consistent and the battery safety is ensured.

Hereinafter, examples of the present invention are described in detail.

### Example 1

A battery according to Example 1 of the present invention is explained with reference to FIG. 1.

The nonaqueous electrolyte secondary battery shown in FIG. 1 includes a metal battery case 1 and an electrode group 8 placed in the battery case 1. The electrode group 8 includes a positive electrode 4, a negative electrode 5 and a polyethylene separator 6. The positive electrode 4 and the negative electrode 5 are wound into a spiral with the separator 6 interposed therebetween. An upper insulating plate 7a is provided above the electrode group 8 and a lower insulating plate 7b is provided below the electrode group 8. A sealing plate 2 is laser-welded to the opening end of the battery case 1 with a gasket 3 interposed therebetween. Thus, the battery case is sealed.

An aluminum positive electrode lead 4a is fixed to the positive electrode 4 at one end and connected to the sealing plate 2 which also functions as a positive electrode terminal at the other end. A copper negative electrode lead 5a is fixed to the negative electrode 5 at one end and connected to the closed end of the battery case 1 which also functions as a negative electrode terminal at the other end.

### 1) Preparation of Positive Electrode

### —First Material Mixture Layer—

To 100 parts by weight of LiNi_{0.80}CO_{0.10}Al_{0.10}O₂ as a positive electrode active material, 1.25 parts by weight of acetylene black (carbon material) as a conductive material, an emulsion prepared by dispersing 3 parts by weight of polytetrafluoroethylene (PTFE) as a first binder in water and an aqueous solution dissolving 1 part by weight of carboxymethyl cellulose (CMC) as a thickener were mixed to prepare paste containing a positive electrode material mixture (first material mixture slurry). The paste was applied to a 15 μm thick aluminum foil (positive electrode current collector) and dried to form a first material mixture layer.

Then, the positive electrode current collector carrying the first material mixture layer on each of the surfaces thereof was heat-treated at 250° C. for 10 hours to decompose CMC contained in the first material mixture layer.

### —Second Material Mixture Layer—

To 100 parts by weight of LiNi_{0.80}Co_{0.10}Al_{0.10}O₂ as a positive electrode active material, 1.25 parts by weight of acetylene black as a conductive material and a solution prepared by dissolving 1.7 parts by weight of polyvinylidene fluoride (PVDF) as a second binder in a N-methylpyrrolidone (NMP) solvent were mixed to prepare paste containing a positive electrode material mixture (second material mixture slurry). The paste was applied to the first material mixture layer and dried to form a second material mixture layer.

Then, the positive electrode current collector carrying the first and second material mixture layers stacked in this order on each of the surfaces thereof was rolled and cut to obtain a positive electrode of 0.125 mm thick, 57 mm wide and 667 mm long. In this manner, the positive electrode (4 in FIG. 2) was prepared in which a positive electrode material mixture layer (1B in FIG. 2) including the first material mixture layer (11 in FIG. 2) and the second material mixture layer (12 in FIG. 2) stacked in this order was formed on each of the surfaces of the positive electrode current collector (1A in FIG. 2).

The positive electrode material mixture layer was prepared such that LiNi_{0.80}Co_{0.10}Al_{0.10}O₂ in the first material mixture layer and LiNi_{0.80}Co_{0.10}Al_{0.10}O₂ in the second material mixture layer were in the weight ratio of 1:9.

### 2) Preparation of Negative Electrode

First, 100 parts by weight of flake artificial graphite was ground and classified to have an average particle diameter of about 20 μm.

Then, to 100 parts by weight of flake artificial graphite as a negative electrode active material, 3 parts by weight of styrene butadiene rubber as a binder and a solution containing 1 wt % of carboxymethyl cellulose were mixed to prepare paste containing a negative electrode material mixture (negative electrode material mixture slurry). Then, the paste was applied to a 8 μm thick copper foil (negative electrode current collector) and dried. Then, the resulting product was rolled and cut to obtain a negative electrode of 0.156 mm thick, 58.5 mm wide and 750 mm long.

### 3) Preparation of Nonaqueous Electrolyte Solution

To a solution mixture of ethylene carbonate and dimethyl carbonate in the volume ratio of 1:3 as a nonaqueous solvent, 5 wt % of vinylene carbonate was added as an additive and LiPF₆ as an electrolyte was dissolved in a concentration of 1.4 mol/m³. In this manner, a nonaqueous electrolyte solution was prepared.

### 4) Preparation of Nonaqueous Electrolyte Secondary Battery

First, a positive electrode lead made of aluminum (4a in FIG. 1) was fixed to the positive electrode current collector and a negative electrode lead made of nickel (5a in FIG. 1) was fixed to the negative electrode current collector. Then, the positive electrode (4 in FIG. 1) and the negative electrode (5 in FIG. 1) were wounded into spiral with the polyethylene separator (6 in FIG. 1) interposed therebetween to provide an electrode group (8 in FIG. 1).

An upper insulating plate (7a in FIG. 1) was arranged above the electrode group and a lower insulating plate (7b in FIG. 1) was arranged below the electrode group. Then, the negative electrode lead was welded to the battery case (1 in FIG. 1) and the positive electrode lead was welded to a sealing plate (2 in FIG. 1) having a safety valve operated by inner pressure. Thus, the electrode group was placed in the battery case.

A nonaqueous electrolyte solution was then poured in the battery case under reduced pressure. Then, an opening end of the battery case was crimped to the sealing plate with a gasket (3 in FIG. 1) interposed therebetween to complete a nonaqueous electrolyte secondary battery. The thus obtained battery is referred to as Battery 1.

### Comparative Example 1

A battery of Comparative Example 1 is explained below.

The battery of Comparative Example 1 is different from that of Example 1 in the following point.

In Example 1, the positive electrode material mixture layer including the first material mixture layer (a layer formed by applying and drying a first material mixture slurry prepared by mixing a first material mixture with water) and the second material mixture layer (a layer formed by applying and drying a second material mixture slurry prepared by mixing a second material mixture with an organic solvent) stacked in this order was formed on each of the surfaces of the positive electrode current collector to prepare the positive electrode. In Comparative Example 1, unlike Example 1, a positive electrode material mixture layer including the second and first material mixture layers stacked in this order was formed on each of the surfaces of the positive electrode current collector to prepare the positive electrode. To be more specific, in Example 1, the first material mixture layer was formed first and then the second material mixture layer was formed thereon in 1) Preparation of the positive electrode. In Comparative Example 1, the second material mixture layer was formed first and then the first material mixture layer was formed thereon.

### 1) Preparation of Positive Electrode

### —Second Material Mixture Layer—

First, to 100 parts by weight of LiNi_{0.80}Co_{0.10}Al_{0.10}O₂ as a positive electrode active material, 1.25 parts by weight of acetylene black as a conductive material and a solution prepared by dissolving 1.7 parts by weight of PVDF as a binder in an NMP solvent were mixed to prepare paste containing a positive electrode material mixture (second material mixture slurry). The paste was applied to a 15 μm thick positive electrode current collector and dried to form a second material mixture layer.

### —First Material Mixture Layer—

Then, to 100 parts by weight of LiNi_{0.80}Co_{0.10}Al_{0.10}O₂ as a positive electrode active material, 1.25 parts by weight of acetylene black as a conductive material, an emulsion prepared by dispersing 3 parts by weight of PTFE as a first binder in water and an aqueous solution dissolving 1 part by weight of CMC as a thickener were mixed to prepare paste containing a positive electrode material mixture (first positive electrode material mixture slurry). The paste was applied to the second material mixture layer and dried to form a first material mixture layer.

Then, the positive electrode current collector carrying the second and first material mixture layers were stacked in this order on each of the surfaces thereof was heat-treated at 250° C. to decompose CMC contained in the first material mixture layer.

Then, the positive electrode current collector carrying the second and first material mixture layers were stacked in this order on each of the surfaces thereof was rolled and cut to form a positive electrode of 0.125 mm thick, 57 mm wide and 667 mm long.

The positive electrode material mixture layer was prepared such that LiNi_{0.80}Co_{0.10}Al_{0.10}O₂ in the second material mixture layer and LiNi_{0.80}Co_{0.10}Al_{0.10}O₂ in the first material mixture layer were in the weight ratio of 1:9.

The battery was formed in the same manner as that of Example 1 except that the positive electrode was prepared in which the positive electrode material mixture layer including the second and first material mixture layers stacked in this order was formed on each of the surfaces of the positive electrode current collector. The thus-formed battery is referred to as Battery 2.

### Comparative Example 2

A battery of Comparative Example 2 is explained below.

The battery of Comparative Example 2 is different from that of Example 1 in the following point.

In Example 1, the positive electrode material mixture layer including the first and second material mixture layers stacked in this order was formed on each of the surfaces of the positive electrode current collector to prepare the positive electrode. In Comparative Example 2, unlike Example 1, a positive electrode material mixture layer including only the first material mixture layer was formed on each of the surfaces of the positive electrode current collector to prepare the positive electrode.

First, to 100 parts by weight of LiNi_{0.80}Co_{0.10}Al_{0.10}O₂ as a positive electrode active material, 1.25 parts by weight of acetylene black as a conductive material, an emulsion prepared by dispersing 3 parts by weight of PTFE as a first binder in water and an aqueous solution dissolving 1 part by weight of CMC as a thickener were mixed to prepare paste containing a positive electrode material mixture (first material mixture slurry). The paste was applied to a 15 μm thick positive electrode current collector and dried to form a first material mixture layer.

Then, the positive electrode current collector carrying the first material mixture layer on each of the surfaces thereof was heat-treated at 250° C. to decompose CMC contained in the first material mixture layer.

Then, the positive electrode current collector carrying the first material mixture layer on each of the surfaces thereof was rolled and cut to form a positive electrode of 0.125 mm thick, 57 mm wide and 667 mm long.

The battery was formed in the same manner as that of Example 1 except that the positive electrode was prepared in which the positive electrode material mixture layer including only the first material mixture layer was formed on each of the surfaces of the positive electrode current collector. The thus-formed battery is referred to as Battery 3.

### Comparative Example 3

A battery of Comparative Example 3 is explained below.

The battery of Comparative Example 3 is different from that of Example 1 in the following point.

In Example 1, the positive electrode material mixture layer including the first and second material mixture layers stacked in this order was formed on each of the surfaces of the positive electrode current collector to prepare the positive electrode. In Comparative Example 3, unlike Example 1, a positive electrode material mixture layer including only the second material mixture layer was formed on each of the surfaces of the positive electrode current collector to prepare the positive electrode.

First, to 100 parts by weight of LiNi_{0.80}Co_{0.10}Al_{0.10}O₂ as a positive electrode active material, 1.25 parts by weight of acetylene black as a conductive material and a solution dissolving 1.7 parts by weight of PVDF as a second binder in a NMP solvent were mixed to prepare paste containing a positive electrode material mixture (second material mixture slurry). The paste was applied to a 15 μm thick positive electrode current collector and dried to form a second material mixture layer.

The positive electrode current collector carrying the second material mixture layer on each of the surfaces thereof was rolled and cut to form a positive electrode of 0.125 mm thick, 57 mm wide and 667 mm long.

The battery was formed in the same manner as that of Example 1 except that the positive electrode was prepared in which the positive electrode material mixture layer including only the second material mixture layer was formed on each of the surfaces of the positive electrode current collector. The thus-formed battery was referred to as Battery 4.

### <Nail Penetration Test>

A nail penetration test was performed on Battery 1 of Example 1 and Batteries 2 to 4 of Comparative Example 1 to 3 to evaluate the safety of Batteries 1 to 4. Conditions of the nail penetration test are briefly explained below.

Batteries 1 to 4 were charged at a constant current of 1.45 A to a voltage of 4.25 V and then charged at a constant voltage to a current of 50 mA. Then, a nail of 2.7 mm diameter was inserted to penetrate the center of each of Batteries 1 to 4 at 5 mm/sec in an environment of 60° C. to observe a change in appearance of the battery. Further, five sets of Batteries 1 to 4 were prepared and subjected to the nail penetration test. Specifically, the nail of 2.7 mm diameter was inserted to penetrate the center of each of the batteries at 150 m/sec in an environment of 75° C. to check the number of batteries that generated smoke. Table 1 shows the results.

### <Battery Capacity Measurement>

Capacities of Battery 1 of Example 1 and Batteries 2 to 4 of Comparative Example 1 to 3 were measured under the following conditions.

In an environment of 25° C., each of Batteries 1 to 4 was charged at a constant current of 1.4 A to a voltage of 4.2 V and then charged at a constant voltage of 4.2 V to a current of 50 mA. Then, the battery was discharged at a constant current of 0.56 A to a voltage of 2.5 V. After that, the capacity of each of Batteries 1 to 4 was measured. Table 1 shows the measurement results.

TABLE 1

| | | Nail | Battery |
|---|---|---|---|
| | | penetration | capacity |
| | | test | (mAh) |
| Battery 1 | 2^{nd} material mixture layer/ | 0/5 | 2800 |
| | 1^{st} material mixture layer/ | | |
| | current collector | | |
| Battery 2 | 1^{st} material mixture layer/ | 3/5 | 2650 |
| | 2^{nd} material mixture layer/ | | |
| | current collector | | |
| Battery 3 | 1^{st} material mixture layer/ | 0/5 | 2600 |
| | current collector | | |
| Battery 4 | 2^{nd} material mixture layer/ | 5/5 | 2850 |
| | current collector | | |

### —Results of Nail Penetration Test—

As shown in Table 1, smoke was not generated from Batteries 1 and 3 each including the first material mixture layer (a layer formed by applying and drying a first material mixture slurry prepared by mixing a first material mixture with water) formed in contact with the positive electrode current collector. Specifically, Battery 1 includes the positive electrode prepared by forming the positive electrode material mixture layer including the first and second material mixture layers stacked in this order on the positive electrode current collector. Battery 3 includes the positive electrode prepared by forming the positive electrode material mixture layer including only the first material mixture layer on the positive electrode current collector.

In contrast, smoke was generated from some of Batteries 2 and 4 each including the second material mixture layer (a layer formed by applying and drying a second material mixture slurry prepared by mixing a second material mixture with NMP) formed in contact with the positive electrode current collector. Specifically, Battery 2 includes the positive electrode prepared by forming the positive electrode material mixture layer including the second and first material mixture layers stacked in this order on the positive electrode current collector. Battery 4 includes the positive electrode prepared by forming the positive electrode material mixture layer including only the second material mixture layer on the positive electrode current collector.

A presumable reason why the smoke was not generated from Batteries 1 and 3 is described below. When the first material mixture slurry is applied to the positive electrode current collector made of aluminum, the surface of the positive electrode current collector is corroded as it contacts water contained in the first material mixture slurry and an aluminum oxide coating is formed at the interface between the positive electrode current collector and the first material mixture layer (the coating is thicker than an aluminum oxide film usually generated on aluminum). This coating restrains the flow of a short circuit current when the short circuit occurs in the battery. Therefore, the battery safety is improved.

### —Result of Battery Capacity Measurement—

As shown in Table 1, the capacities of Batteries 1 to 4 correspond to the ratio of the weight of the positive electrode active material in the first material mixture layer (a layer formed by applying and drying a first material mixture slurry prepared by mixing a first material mixture with water) and the weight of the positive electrode active material in the second material mixture layer (a layer formed by applying and drying a second material mixture slurry prepared by mixing a second material mixture with NMP). To be more specific, the higher the weight ratio of the positive electrode active material contained in the second material mixture layer of the positive electrode material mixture layer is, the higher the battery capacity becomes.

More specifically, as to Batteries 1 and 2 in each of which the positive electrode material mixture layer includes the first and second material mixture layers, the ratio (the weight of the positive electrode active material in the first material mixture layer):(the weight of the positive electrode active material in the second material mixture layer) is 1:9 in Battery 1, whereas it is 9:1 in Battery 2. Battery 3 includes the positive electrode material mixture layer including only the first material mixture layer, whereas Battery 4 includes the positive electrode material mixture layer including only the second material mixture layer.

Therefore, as shown in Table 1, among the four kinds of batteries, Battery 4 showed the highest battery capacity (2850 mAh) as the weight ratio of the positive electrode active material contained in the second material mixture layer of the positive electrode material mixture layer is 100%. Battery 1 showed the second highest battery capacity (2800 mAh) as the weight ratio of the positive electrode active material contained in the second material mixture layer of the positive electrode material mixture layer is 90%.

On the other hand, Battery 3 showed the lowest battery capacity (2600 mAh) as the weight ratio of the positive electrode active material contained in the second material mixture layer of the positive electrode material mixture layer is 0% (i.e., the weight ratio of the positive electrode active material contained in the first material mixture layer of the positive electrode material mixture layer is 100%). Battery 2 showed the second lowest battery capacity (2650 mAh) as the weight ratio of the positive electrode active material contained in the second material mixture layer of the positive electrode material mixture layer is 10%. A presumable cause of the relatively low battery capacity of Batteries 2 and 3 is that lithium in the positive electrode active material is eluted in water in the process of forming the first material mixture layer.

As described above, Batteries 1 and 3 did not generate smoke in the nail penetration test and were proved to have excellent safety, but Battery 3 did not have sufficiently high battery capacity. Batteries 1 and 4 were proved to have sufficiently high battery capacity and excellent battery performance, but some of Batteries 4 generated smoke in the nail penetration test. That is, excellent safety and superior electrical performance are simultaneously realized only by Battery 1.

The nonaqueous electrolyte secondary battery which offers excellent safety and superior electrical performance is provided when the following conditions 1) and 2) are met. Although the capacity of Battery 1 is lower than that of Battery 4, it is still high and practically sufficient.

Condition 1):

The first material mixture slurry prepared by mixing the first material mixture with “water” is applied to the positive electrode current collector and dried to form the first material mixture layer, thereby forming an aluminum oxide film (i.e., a resistive film) at the interface between the positive electrode current collector and the first material mixture layer.

Condition 2):

The second material mixture slurry prepared by mixing the second material mixture with an “organic solvent” is applied to the first material mixture layer and dried to form the second material mixture layer on the first material mixture layer.

As described above, the present invention makes it possible to provide a nonaqueous electrolyte secondary battery having excellent safety and superior electrical performance. Therefore, the invention is applicable as a driving source for electrical devices, for example.

What is claimed is:

1. A nonaqueous electrolyte secondary battery comprising a positive electrode including a positive electrode current collector carrying a positive electrode material mixture layer thereon, a negative electrode including a negative electrode current collector carrying a negative electrode material mixture layer thereon, a separator provided between the positive electrode and the negative electrode and a nonaqueous electrolyte solution, wherein
the positive electrode current collector is a conductive body containing aluminum,
the positive electrode material mixture layer includes a first material mixture layer and a second material mixture layer formed on the first material mixture layer,
the first material mixture layer is made of a first material mixture containing a first organic material which is soluble or dispersible in water and
the second material mixture layer is made of a second material mixture containing a second organic material which is soluble or dispersible in an organic solvent.

2. The nonaqueous electrolyte secondary battery of claim 1, wherein
the first material mixture layer is a layer formed by drying a first solution mixture prepared by mixing the first material mixture with water and
the second material mixture layer is a layer formed by drying a second solution mixture prepared by mixing the second material mixture with an organic solvent.

3. The nonaqueous electrolyte secondary battery of claim 2, wherein
an aluminum oxide coating is formed at an interface between the positive electrode current collector and the first material mixture layer by a reaction between water in the first solution mixture and aluminum in the positive electrode current collector.

4. The nonaqueous electrolyte secondary battery of claim 1, wherein
the first material mixture contains a conductive material made of a carbon material.

5. The nonaqueous electrolyte secondary battery of claim 1, wherein
the first material mixture contains a positive electrode active material made of aluminum-containing lithium composite oxide.

6. The nonaqueous electrolyte secondary battery of claim 1, wherein
the first material mixture contains a positive electrode active material made of nickel-containing lithium composite oxide.

7. The nonaqueous electrolyte secondary battery of claim 1, wherein
the first material mixture contains a first binder made of the first organic material and the second material mixture contains a second binder made of the second organic material.

8. The nonaqueous electrolyte secondary battery of claim 7, wherein
the first binder contains polytetrafluoroethylene, denatured polytetrafluoroethylene, a tetrafluoroethylene-hexafluoropropylene copolymer or a denatured tetrafluoroethylene-hexafluoropropylene copolymer and
the second binder contains polyvinylidene fluoride or denatured polyvinylidene fluoride.

9. A nonaqueous electrolyte secondary battery comprising a positive electrode including a positive electrode current collector carrying a positive electrode material mixture layer thereon, a negative electrode including a negative electrode current collector carrying a negative electrode material mixture layer thereon, a separator provided between the positive electrode and the negative electrode and a nonaqueous electrolyte solution, wherein
the positive electrode current collector is a conductive body containing aluminum and
an undercoating containing an organic material which is soluble or dispersible in water and a conductive material made of a carbon material is provided between the positive electrode current collector and the positive electrode material mixture layer.

10. The nonaqueous electrolyte secondary battery of claim 9, wherein
the undercoating is formed by drying a solution mixture prepared by mixing the organic material and the conductive material into water.

11. The nonaqueous electrolyte secondary battery of claim 10, wherein
an aluminum oxide coating is formed at an interface between the positive electrode current collector and the undercoating by a reaction between water in the solution mixture and aluminum in the positive electrode current collector.

12. The nonaqueous electrolyte secondary battery of claim 1, wherein
a positive electrode active material contained in the positive electrode material mixture layer is a compound represented by a general formula of LiNiₓCo_{y}Al_{1-x-y}O₂, where 0.7<x<1.0 and 0<y<0.3.

13. The nonaqueous electrolyte secondary battery of claim 9, wherein
a positive electrode active material contained in the positive electrode material mixture layer is a compound represented by a general formula of LiNiₓCo_{y}Al_{1-x-y}O₂ where 0.7<x<1.0 and 0<y<0.3.

14. A method for manufacturing a positive electrode of a nonaqueous electrolyte secondary battery comprising the steps of:
(a) applying to an aluminum-containing positive electrode current collector a first material mixture slurry prepared by mixing a first material mixture containing a first organic material which is soluble or dispersible in water with water and drying the applied slurry to form a first material mixture layer; and
(b) applying to the first material mixture layer a second material mixture slurry prepared by mixing a second material mixture containing a second organic material which is soluble or dispersible in an organic solvent with an organic solvent and drying the applied slurry to form a second material mixture layer after the step (a).

15. The method for manufacturing a positive electrode of a nonaqueous electrolyte secondary battery of claim 14, wherein
in the step (a), an aluminum oxide coating is formed at an interface between the positive electrode current collector and the first material mixture layer by a reaction between water in the first material mixture slurry and aluminum in the positive electrode current collector.

16. The method for manufacturing a positive electrode of a nonaqueous electrolyte secondary battery of claim 14, wherein
the first material mixture contains a conductive material made of a carbon material.

17. A method for manufacturing a positive electrode of a nonaqueous electrolyte secondary battery comprising the steps of:
(a) applying to an aluminum-containing positive electrode current collector a slurry prepared by mixing an organic material which is soluble or dispersible in water and a conductive material made of a carbon material into water and drying the applied slurry to form an undercoating; and
(b) applying to the undercoating a material mixture slurry made of a material mixture and drying the applied slurry to form a positive electrode material mixture layer after the step (a).

18. The method for manufacturing a positive electrode of a nonaqueous electrolyte secondary battery of claim 17, wherein
in the step (a), an aluminum oxide coating is formed at an interface between the positive electrode current collector and the undercoating by a reaction between water in the slurry and aluminum in the positive electrode current collector.
